(19) United States
(12) Patent Application Publication
(10) Pub. No.: US 2024/0271540 A1
(43) Pub. Date: Aug. 15, 2024

(54) ADJUSTMENT SYSTEM FOR A COMPRESSOR

(71) Applicant: MTU Aero Engines AG, München (DE)

(72) Inventor: Alexander Boeck, Kottgeisering (DE)

(73) Assignee: MTU Aero Engines AG, München (DE)

(21) Appl. No.: 18/439,495

(22) Filed: Feb. 12, 2024

(30) Foreign Application Priority Data
Feb. 15, 2023 (DE) 10 2023 103 730.7

(51) Int. Cl. F01D 9/04

(52) U.S. Cl. CPC F01D 9/041

(57) ABSTRACT

The invention relates to an adjustment system for a compressor in a gas turbine, in particular in an aircraft gas turbine, for the adjustment of adjustable guide vanes, including an actuator device with a first actuator for the adjustment of the guide vanes and an adjusting device with a first adjusting valve for the hydraulic operation of the first actuator, wherein the adjusting device can adjust and lock in position the first actuator by way of the hydraulic operation, is characterized in that the actuator device is assigned a locking device for additional fixation and can be fixed in a position by the locking device.

### BACKGROUND OF THE INVENTION

The invention relates to an adjustment system for a compressor in a gas turbine, in particular in an aircraft gas turbine, for the adjustment of adjustable guide vanes, comprising an actuator device with a first actuator for the adjustment of the guide vanes and an adjusting device with a first adjusting valve for the hydraulic operation of the first actuator, wherein the adjusting device can adjust and lock in position the first actuator by way of the hydraulic operation.

Adjustment systems of this kind are subjected to high loads on the part of the flow channel, which can lead to wear of the components involved.

### SUMMARY OF THE INVENTION

Therefore, it is the object of the invention to specify an adjustment system that exhibits a reduced wear.

For the adjustment of adjustable guide vanes, an adjustment system according to the invention has an actuator device with a first actuator for the adjustment of the guide vanes and an adjusting device with a first adjusting valve for the hydraulic operation of the first actuator, wherein the adjusting device can adjust and lock in position the first actuator by way of the hydraulic operation.

The object is achieved by the adjustment system according to the present invention in that the actuator device is assigned a locking device for additional fixation and can be fixed in a position by the locking device. By way of the additional fixation, it is possible to prevent or at least to reduce any movement of the actuators or of the actuator device and thereby of the guide vanes and thus to reduce advantageously the load and the wear of the journal bearings of the guide vanes. This is advantageous, in particular, when, in its zero setting, the adjusting valve is not fully tight. In this case, it is pressed out of the zero position by the forces emanating from the engine. Once a threshold value has been exceeded, the regulator engages and triggers a reverse movement. Depending on the leakage in the adjusting valve, this can happen more frequently per second, thereby leading to permanent, very small movements in the system. These movements lead to a wear, which is reduced or prevented by the solution according to the invention. The actuator device can have a second actuator, which can likewise be controlled hydraulically by the first adjusting device. In this configuration, the first actuator and the second actuator can form a master-slave system, in which only the position of the first actuator as master is decisive for the control of the actuator device. The two actuators can be in fluidic connection with each other, with the respective interior of the actuators being divided into two chambers by an actuator piston and with one of the two chambers of the one actuator being in fluidic connection with one of the two respective chambers of the other actuator. In this way, the two actuators can be controlled and moved jointly in a simple way.

Further advantages and features ensue from the following description of some preferred exemplary embodiments as discussed in detail below.

In another embodiment of the adjustment system, it is provided that the locking device can hydraulically lock and release the actuator device, in particular the first actuator. By way of a hydraulic fixation, an especially simple system is created, because, to this end, no further adjusting elements or modifications of the actuators are necessary. In an alternative embodiment, the locking device can bring about a mechanical locking of the actuator device and, for this purpose, can be controlled hydraulically or electronically. In another embodiment, the actuator can be locked electromagnetically by the locking device.

In an advantageous further development, the adjustment system can be further developed in such a way that the locking device comprises a first locking valve. A locking valve makes it possible to achieve the additional fixation of the actuator device in an especially simple manner.

Additionally, it can be provided that the first locking valve is arranged in a hydraulic line between the first adjusting valve and the first actuator. In this way, it is possible to separate the first actuator from the remaining hydraulic system and to fix it in place in an especially simple and cost-effective manner.

Furthermore, in another embodiment, the adjustment system can be further developed in such a way that the locking device locks a hydraulic line between the first actuator and the first adjusting valve in a blocking position of the blocking valve, in order to thus fix in place the first actuator. In this way, the blocking position is additionally fixed in place and any drift of the blocking valve is prevented.

Beyond this, the adjustment system can comprise a control instrument for controlling the first adjusting valve, wherein the locking device can be locked and released by the control instrument. The control instrument can be programed depending on the flight conditions and mission types or can else respond to correspondingly transpiring sensor data and, in this way, achieve an actuation of the adjusting valve and of the locking device that is as optimal as possible.

In a further embodiment, the locking device can be locked and released by the control instrument electrically, electromechanically, electrohydraulically, and/or electromagnetically. In this way, a robust actuation is achieved.

Furthermore, in a further embodiment, it can be provided that the first actuator has a first sensor for the detection of a position of the first actuator, wherein the sensor is electronically connected to the control instrument for signal transmission, and that the locking device is locked or released by the control instrument depending on the position of the first actuator. This makes possible in an advantageous manner a precise regulation of the adjustment system. In connection with the fluidic connection of the two above-described actuators in a master-slave system, a simple regulation of a plurality of actuators, connected in series, on the circumference of a single adjusting ring or of a group of adjusting rings is hereby also possible, whereby the slave actuator is not actively regulated, but rather only transmits the adjusting force onto a second position on the circumference of the adjusting ring or the group of adjusting rings.

In an advantageous further development of the adjustment system, the first adjusting valve can be a proportional valve, in particular a servovalve, especially preferably an electrically actuated, hydraulically operated servovalve in a 4/3 directional valve with a middle blocking position. Proportional valves allow a very good control of the adjustment system and servovalves, in particular, represent a very precise and robust possibility for the control of the hydraulic flow of the adjustment system. Servovalves make it possible to overcome very well the high forces arising in the flow channel of the gas turbine and nonetheless to adjust the guide vanes precisely. Particularly in combination with an additional locking device, it is also possible to reduce or prevent the forces that arise in a locked position, in which the servovalve is intended only to seal. In this way, it is possible in an advantageous manner to avoid any readjustment.

Furthermore, the actuator device can comprise a second actuator, wherein the adjusting device can comprise a second adjusting valve for the hydraulic operation of the second actuator and wherein the second adjusting valve can adjust and lock in position the second actuator by way of the hydraulic operation. An independent actuation of the two actuators is thereby created. This is advantageous when, for example, a plurality of adjusting rings are to be actuated, each of them by its own actuator. Beyond this, it is also possible to provide more than two actuators, which are designed in an analogous way. Furthermore, it is also possible for two or more actuators to actuate one adjusting ring or a plurality of adjusting rings at the same time in analogy to the above description, with the actuators then being arranged in an advantageous manner in uniform distribution around the one adjusting ring or the plurality of adjusting rings.

Finally, in a further embodiment, the locking device can comprise a second locking valve, wherein the second locking valve can be arranged in a second hydraulic line between the second adjusting valve and the second actuator. In this way, the actuators can be fixed in place separately in an advantageous manner, thereby enabling an especially precise control of the adjustment system.

### BRIEF DESCRIPTION OF THE DRAWING FIGURES

The invention will be explained in detail with reference to the following drawings based on some preferred exemplary embodiments of the invention.

FIG. 1 shows a first exemplary embodiment of an adjustment system according to the invention, illustrated in a meridional section, of an aircraft gas turbine.

FIG. 2a shows the first exemplary embodiment of an adjustment system according to the invention in a schematic illustration.

FIG. 2b shows the first exemplary embodiment of an adjustment system according to the invention in a schematic illustration with a group of adjusting rings.

FIG. 3 shows a second exemplary embodiment of an adjustment system according to the invention in a schematic illustration.

FIG. 4a shows a third exemplary embodiment of an adjustment system according to the invention in a schematic illustration.

FIG. 4b shows the first exemplary embodiment of an adjustment system according to the invention in a schematic illustration with a group of adjusting rings.

### DESCRIPTION OF THE INVENTION

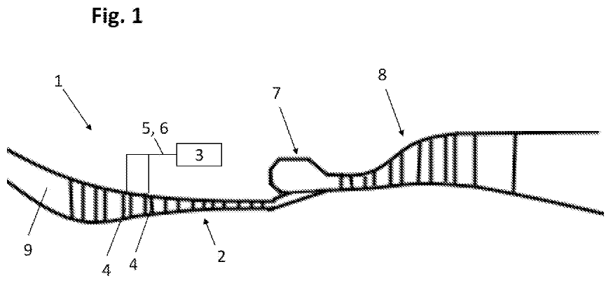

In FIG. 1, a gas turbine 1, designed as an aircraft gas turbine, is illustrated, which comprises a compressor 2, the stator stages or which are designed to be adjustable and are actuated by an adjustment system 3. Each stator stage comprises a plurality of adjustable guide vanes 4, which can be adjusted by the adjustment system 3 by way of a respective adjusting ring 5 and a respective adjusting lever 6. Hereby provided on each adjusting ring 5 are a plurality of adjusting levers 6 for the actuation of the respective guide vanes 4. If, as illustrated in FIG. 1, a plurality of guide vane stages or stator stages are to be adjusted, then it is possible to provide a group of adjusting rings 5, of which one adjusting ring 5 each is assigned to a guide vane stage or a stator stage. The guide vanes 4 are rotatably mounted around their axis of rotation, which is formed by a bearing journal, which is not illustrated, and can be rotated by the respective adjusting lever 6, which, in turn, is twisted by the respective adjusting ring 5.

Furthermore, upstream of the compressor 2, the gas turbine 1 comprises a combustion chamber 7 and a turbine 8, which are arranged jointly with the compressor 2 in a flow channel 9, in particular a core flow channel of the gas turbine 1.

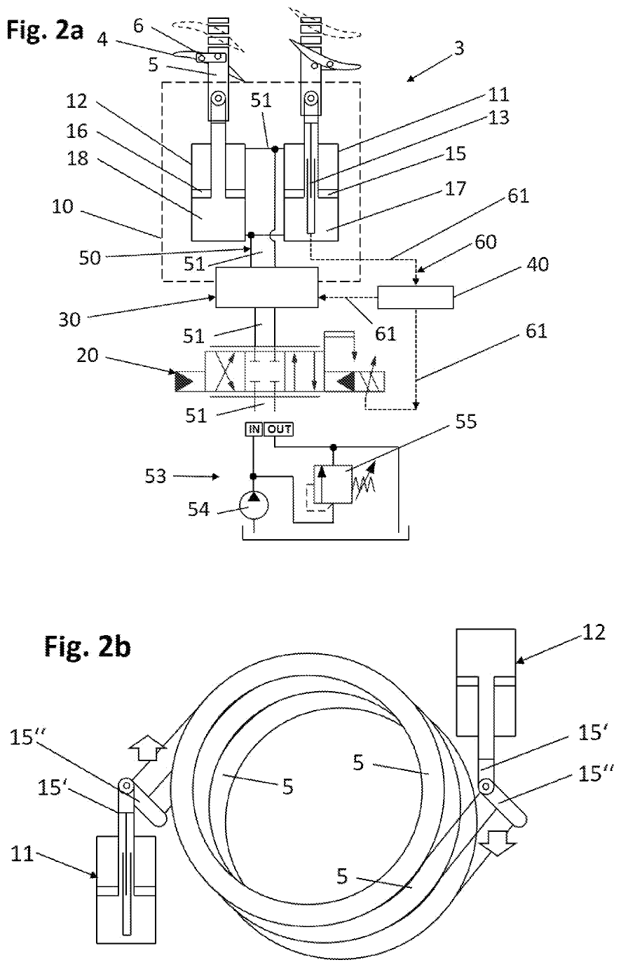

On the basis of the schematic illustrations depicted in FIGS. 2a to 4b, the invention will now be explained in detail.

FIG. 2a shows a schematic illustration of the first exemplary embodiment of the adjustment system 3. The adjustment system 3 comprises an actuator device 10 for the movement and adjustment of the adjusting ring 5 or the group of adjusting rings 5, with a plurality of the adjusting levers 6 being arranged on each of the adjusting rings 5 and with each of the adjusting rings 5 being connected via one of the respective adjusting levers 6 to one of the guide vanes 4 or the plurality of guide vanes 4.

The adjustment system 3 further comprises an adjusting device 20, which is connected hydraulically to the actuator device 10 and is actuated by a control instrument 40. Furthermore, a locking device 30 is assigned to the actuator device 10 and can additionally lock the actuator device 10. The actuator device 10 is supplied with hydraulic fluid by a hydraulic system 50 and can communicate via an electrical system 60 with the control instrument 40, whereby, on the basis of a position of the actuator device 10, the control instrument 40 controls the adjusting device 20. On the basis of the actuation by the control instrument 40, the adjusting device 20 controls the flow of the hydraulic fluid to the actuator device 10.

The actuator device 10 comprises a first actuator 11 and a second actuator 12. The two actuators 11, 12 are both designed as doubly acting cylinders, whereby the actuators 11, 12 each have an actuator piston 15, 16, which is connected to and moves with an adjusting ring 5 or a group of adjusting rings 5 via a respective piston rod 15′, 16′ and a respective linkage rod 15″, 16″, which is arranged on the corresponding piston rod. A group of adjusting rings 5 is hereby illustrated schematically in FIG. 2b. The actuators 11, 12 are hereby arranged in distribution around the adjusting ring 5 or the group of adjusting rings 5. Illustrated schematically in FIG. 1 are two adjusting rings 5. What is involved, however, is the same adjusting ring 5, with the actuators not being arranged next to one another, as illustrated, but rather being arranged and moving at different positions around the adjusting ring 5 or the group of adjusting rings 5. In the present exemplary embodiment, the first actuator 11 has a sensor 13, which detects the adjustment path of the actuator piston 15 and signals it to the control instrument 40. On account of their design, both actuators 11, 12 have an actuator interior 17, 18, in which the respective actuator piston 15, 16 moves, as a result of which two chambers that are separated by the respective actuator piston 15, 16 are formed. The two chambers of the respective actuator pistons 15, 16 are each attached to a separate hydraulic line 51 and each of which is actuated individually with hydraulic fluid from the hydraulic system 50. In the present exemplary embodiment, the two actuators 11, 12 or one each of their respective chambers are or is in fluidic connection with one of the two chambers of the other actuator, as a result of which an equalization of pressure can take place and the two actuators can be operated hydraulically in a uniform manner. The flow of the hydraulic fluid is controlled by way of the adjusting device 20, to which end the adjusting device 20 has a first control valve 21. The first control valve 21, designed as a servovalve, is a 4/3 directional valve with a middle blocking position and is attached with a respective connection on one of the two hydraulic lines 51 to the chambers of the respective actuator. A first position permits a through flow in a first direction, the second middle position is designed as a blocking position, and a third position permits a through flow in a second opposite direction. The blocking position serves to hold the actuators 11, 12 in position, whereas the first and third positions expose the actuator piston 15, 16 to a force and shift it, as a result of which, in end effect, the guide vanes 4 are adjusted. The first control valve 21 is adjusted in the three positions electrohydraulically by the control instrument 40.

The hydraulic system 50 provides the requisite pressure in the hydraulic lines 51 and at the actuator device 10 or the adjusting device 20 via a hydraulic pump 54 from a hydraulic reservoir 53, whereby, between the hydraulic pump 54 that is attached to a supply line (IN) and a discharge line (OUT), a pressure sequence valve 55 is inserted and makes it also possible to pump a hydraulic fluid into the discharge line (OUT), when, in the discharge line, the pressure is too low. In this way, in both hydraulic lines, a backflow or a suction of the hydraulic fluid from the hydraulic reservoir 53 into the actuator device 10 is made possible.

It has been found that, during the operation of the gas turbine 1, the actuator device 10 is exposed to constant feedback due to the force of the flow against the guide vanes 4. This leads to a constant migration of the actuator device 10 and the adjusting device 20 and, in consequence thereof, a constant compensation and readjustment of the adjustment system 3 by the control instrument 40. It has hereby been further found that the steadily occurring minimal movements lead to a constant load and abrasion of the bearing journals of the adjustable guide vanes 4.

Additionally in accordance with the invention, therefore a locking device 30 is arranged between the adjusting device 20 and the actuator device 10 in the first exemplary embodiment, with the locking device 30 being likewise actuated by the control instrument 40. The control instrument 40 is hereby connected via electrical conductors 61 to the first actuator 11, the first control valve 21, and the locking device 30 in order to send the control signals or to receive the stroke position of the actuator 11. The locking device 30 can block the actuator device 10 and, in this way, fix a position of the actuators or prevent any movement of the actuators 11, 12. Alternatively or additionally, the locking device 30 can be designed as a disconnecting device and disconnect a hydraulic connection between the actuator device and the adjusting device. In this way, the volume of the hydraulic fluid that is present in the actuator device 10 is fixed and a feedback in the direction of the adjusting device 20, the hydraulic pump 54, or the sequence valve 55 is prevented.

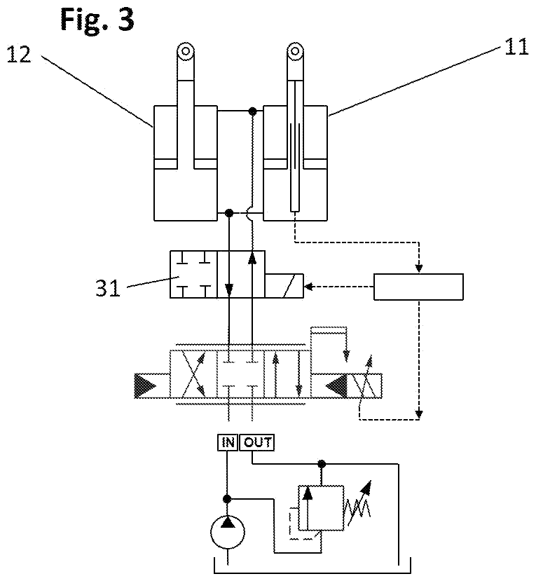

The second exemplary embodiment of an adjustment system 3 according to the invention illustrated in FIG. 3 is described below on the basis of the differences with respect to the first exemplary embodiment:

The locking device 30 comprises a first locking valve 31, which can be operated in a through-flow position and in a blocked position. The first locking valve 31 is actuated electrically and adjusted by way of an electrical conductor 61 by the control instrument 40. The blocked position is selected by the control instrument 40 when the actuators 11, 12 are to be held in position. This breaks the hydraulic connection between the actuators 11, 12 and the first control valve 21, as a result of which the actuators 11, 12 and accordingly the adjustable guide vanes 4 are held in position in a simple way.

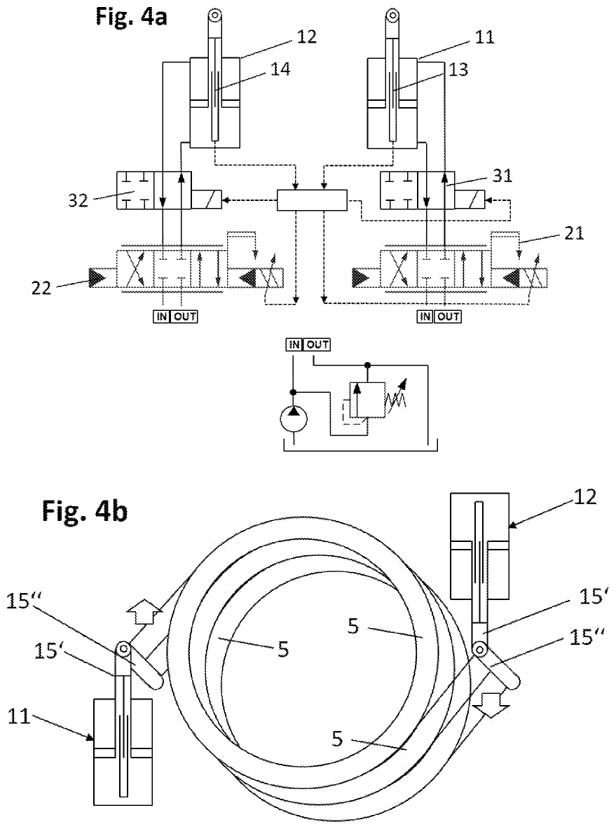

Illustrated in FIG. 4a and FIG. 4b is a third exemplary embodiment of an adjustment system 3 according to the invention. The actuator device 10 has two individually actuatable actuators 11, 12, each of which is assigned its own control valve 21, 22 via a hydraulic line. In contrast to the previous exemplary embodiments, no equalization lines are provided between the interiors 17, 18 of the two actuators 11, 12. In this way, the first actuator 11 can be actuated by the first control valve 21 and the second actuator 12 can be actuated by the second control valve 22 independently of each other. As described for the exemplary embodiment in FIG. 3, the two control valves 21, 22 are each actuated electrically by the control instrument 40 and are adjusted electrohydraulically.

Each of the two actuators 11, 12 is designed with its own sensor 13, 14, which signals to the control instrument 40 the stroke position of the corresponding actuator 11, 12. The control instrument 40 can correspondingly actuate and readjust the actuators 11, 12 individually.

Beyond this, between each of the actuators 11, 12 and the respective hydraulically assigned first control valve 21 or second control valve 22, there is arranged a first locking valve 31 or a second locking valve 32 of the locking device 30. The first locking valve 31 is arranged between the first actuator 11 and the first control valve 21. The second locking valve 32 is arranged between the second actuator 12 and the second control valve 22. The two locking valves 31, 32 can be actuated and adjusted individually by the control instrument 40, as described for the locking valve 31 in the second exemplary embodiment. In this way, each actuator 11, 12 can be individually disconnected hydraulically from the remaining hydraulic system 50 and accordingly additionally fixed in place.

The control instrument 40 is hereby connected via electrical conductors 61 to the first actuator 11 and the second actuator 12, the first control valve 21 and the second control valve 22, and the two locking valves 31, 32 in order to transmit the control signals or in order to receive the stroke of the actuators 11, 12.

What is claimed is:

1. An adjustment system for a compressor in an aircraft gas turbine, for the adjustment of adjustable guide vanes, comprising:
an actuator device with a first actuator for the adjustment of the guide vanes, and
an adjusting device with a first adjusting valve for the hydraulic operation of the first actuator,
wherein the adjusting device adjusts and locks in position the first actuator by way of the hydraulic operation,
wherein the actuator device is assigned a locking device for additional fixation and is fixed in a position by the locking device.

2. The adjustment system according to claim 1, wherein the locking device locks and releases hydraulically the first actuator.

3. The adjustment system according to claim 1, wherein the locking device comprises a first locking valve.

4. The adjustment system according to claim 3, wherein the first locking valve is arranged in a hydraulic line between the first adjusting valve and the first actuator.

5. The adjustment system according to claim 1, wherein the locking device locks a hydraulic line between the first actuator and the first adjusting valve in a blocking position of the adjusting valve to thereby fix in place the first actuator.

6. The adjustment system according to claim 1, further comprising:
a control instrument for the control of the first adjusting valve, wherein the locking device is locked and released by the control instrument.

7. The adjustment system according to claim 6, wherein the locking device is locked and released by the control instrument electrically, electromechanically, electrohydraulically, and/or electromagnetically.

8. The adjustment system according to claim 6, wherein the first actuator has a first sensor for the detection of a position of the first actuator, wherein the sensor is connected electronically to the control instrument for signal transmission, and wherein the locking device is locked or released by the control instrument depending on the position of the first actuator.

9. The adjustment system according to claim 1, wherein the first adjusting valve is an electrically actuated, hydraulically operated servovalve in a 4/3 directional valve with a middle blocking position.

10. The adjustment system according to claim 1, wherein the actuator device comprises a second actuator, wherein the adjusting device comprises a second adjusting valve for the hydraulic operation of the second actuator, and wherein the second adjusting valve adjusts and locks in position the second actuator by the hydraulic operation.

11. The adjustment system according to claim 10, wherein the locking device comprises a second locking valve, and wherein the second locking valve is arranged in a second hydraulic line between the second adjusting valve and the second actuator.
